(19) United States
(12) Patent Application Publication
(10) Pub. No.: US 2014/0230691 A1
(43) Pub. Date: Aug. 21, 2014

(54) COATING AND A METHOD FOR PREPARING THEREOF

(71) Applicants: Riku Talja, Espoo (FI); Jarmo Ropponen, Espoo (FI); Hanne Wikberg, Espoo (FI); Kristiina Poppius-Levlin, Espoo (FI); Ali Harlin, Espoo (FI)

(72) Inventors: Riku Talja, Espoo (FI); Jarmo Ropponen, Espoo (FI); Hanne Wikberg, Espoo (FI); Kristiina Poppius-Levlin, Espoo (FI); Ali Harlin, Espoo (FI)

(73) Assignee: TEKNOLOGIAN TUTKIMUSKESKUS VTT, VTT (FI)

(21) Appl. No.: 14/237,149

(22) PCT Filed: Aug. 2, 2012
(86) PCT No.: PCT/FI2012/050762

§ 371 Date: May 6, 2014

(30) Foreign Application Priority Data
Aug. 5, 2011 (FI) 20115784

(51) Int. Cl. C09D 101/10

(52) U.S. Cl. CPC C09D 101/10
USPC 106/170.27; 427/394; 427/395

(57) ABSTRACT

The invention relates to a method for preparing a thermoplastic coating on a substrate from a hemicellulose polymer or a cellulose polymer wherein the method comprises at least following steps: —providing a cellulose polymer or a hemicellulose polymer having at least one hydroxyl group which can be used for forming cellulose or hemicellulose ester, —reacting hemicellulose polymer or cellulose polymer with a residue originating to fatty acid with an aliphatic carbon tail of 4-28 carbons or ester thereof, for obtaining hemicellulose fatty acid ester or cellulose fatty acid ester, —dispersing the hemicellulose fatty acid ester or cellulose fatty acid ester into aqueous solution, —dispersion coating a substrate with dispersed hemicellulose fatty acid ester or cellulose fatty acid ester for preparing a coated substrate and —heating the coated substrate for preparing a substrate provided with a coating, so that the substrate provided with a coating is heat-sealable with the same substrate provided with said coating or with an uncoated substrate.

The present invention relates to method for preparing a thermoplastic coating on a substrate from a hemicellulose polymer or a cellulose polymer.

The invention relates also to a thermoplastic coating on a substrate, which coating is prepared from a hemicellulose polymer or a cellulose polymer.

Paper and paper-board are manufacture all over the world. Over 40% of these are used in the packaging applications. Traditionally synthetic polymers have been used in paper and paper-board as a barrier coating to increase barrier against water, water vapour, oxygen, aroma and grease. Today there is a need to replace oil-based polymers by natural polymers, e.g. renewable polymers from wood. It is well known that hemicelluloses as such, like other polysaccharides, are good oxygen barriers, but are sensitive to moisture; as water content of hemicellulose increases, it loses oxygen barrier properties. A second serious drawback relating to use of natural polymers, such as hemicellulose, is, that hemicellulose coatings and films do not generally stand for heating and therefore their usage for many applications in paper and paper board industry is very limited because these films or coatings cannot be fixed by heat sealing onto the surface of substrate.

Therefore, the first objective of the invention is to achieve a coating or film, which contains cellulose or hemicellulose and which can be heat-sealed onto the substrate.

The second objective of the invention is to achieve a method for preparing a coating or film, which contains hemicellulose or cellulose so, that this coating or film would have barrier properties against water and water vapour after attaching on a substrate by heat.

The third objective of the invention is to develop an industrially useful method for fixing the film or coating onto a substrate such as material web.

The fourth, general objective, is to get rid off from oil based coating materials and also organic solvents used in methods for applying those oil based materials onto a substrate and to replace them with more ecological materials and coating methods.

The above objectives can be achieved by a coating according to claim 11 and the method according to claim 1.

The method according to invention relates for preparing a thermoplastic coating on a substrate from a hemicellulose polymer or a cellulose polymer wherein the method comprises at least following steps:
providing a cellulose polymer or a hemicellulose polymer having at least one hydroxyl group which can be used for forming cellulose or hemicellulose ester,
reacting hemicellulose polymer or cellulose polymer with a residue originating to hydrophobic fatty acid with an aliphatic carbon tail of 4-28 carbons, preferably of 6-22 carbons or ester thereof for obtaining hemicellulose fatty acid ester or cellulose fatty acid ester,
dispersing the hemicellulose fatty acid ester or cellulose fatty acid ester into aqueous solution and
dispersion coating a fibre web with dispersed hemicellulose fatty acid ester or cellulose fatty acid ester for preparing a coated fibre web,
applying heat and pressure on said coated surface of the fibre web for preparing a fibre web with a coating fixed on its surface,
heat-sealing the coating or the fibre web or part thereof with the coating of the same fibre web or an uncoated fibre web.

The corresponding thermoplastic coating on a substrate is prepared from a hemicellulose polymer or a cellulose polymer by:
providing a cellulose polymer or a hemicellulose polymer having at least one hydroxyl group which can be used for preparing cellulose or a hemicellulose ester,
reacting hemicellulose polymer or cellulose polymer with a residue originating to hydrophilic or hydrophobic fatty acid or ester thereof with an aliphatic carbon tail of 4-28 carbons preferably of 6-22 carbons, for obtaining hemicellulose fatty acid ester or cellulose fatty acid ester,
dispersing the hemicellulose fatty acid ester or cellulose fatty acid ester into aqueous solution,
dispersion coating a substrate with dispersed hemicellulose fatty acid ester or cellulose fatty acid ester for preparing a coated substrate and
applying heat and pressure on said coated surface of the fibre web for preparing a fibre web with a coating fixed on its surface
heat-sealing the coating or the fibre web or part thereof with the coating of the same fibre web or an uncoated fibre web to prepare a heat sealed coating on a fibre web.
The hemicellulose polymer or cellulose polymer means herein both the hemicellulose or cellulose oligomers and polymers.

On a preferred embodiment of the invention a fibre web (for example a paper web) is dispersion coated with an aqueous dispersion containing hemicellulose fatty acid ester polymer or cellulose fatty acid ester polymer, wherein fatty acid ester is originating to a hydrophilic or hydrophobic fatty acid, preferably hydrophobic fatty acid. Fatty acid can be a saturated or an unsaturated.

Thereafter method comprises applying heat and pressure on said coated surface for creating the paper or board with a coating and thereafter heat sealing the paper or paper-board provided with the coating with the same paper or paper-board provided with coating or with an uncoated substrate.

The basic idea behind the present idea is to provide a hemicellulose fatty acid ester polymer or cellulose fatty acid ester polymer, wherein fatty acid ester is originating to a hydrophilic or hydrophobic fatty acid, which is either saturated or unsaturated. Preferably polysaccharide is hemicellulose which contains xylose backbone, which has been esterified with a fatty acid originating to a short, medium or long chain fatty acid with a carbon backbone of 4-28 carbons.

More preferable polysaccharide is hemicellulose which contains xylose backbone, which has been esterified with a fatty acid originating to a short, medium or long chain fatty acid with a carbon backbone of 6-22 carbons more preferably 12-18 carbons.

Fatty acid may be for example palmitic acid, laurc acid, linoleic acid or oleic acid. After synthesizing a fatty acid ester of said polysaccharide this ester is applied on dispersion coating onto the surface of substrate, preferably onto the surface of the fibre web. Thereafter this coated substrate surface is subjected to heat and pressure and activation stage which will evolve a coating on said surface. This surface can be heat sealed with the same surface provided with said coating or another uncoated substrate.

The term “fibre web” means herein the continuous fibre web or uncontinuous fibre web. The former is for example an endless paper or paper board web on a dry end of the paper machine. The latter may be a relatively short paper or paper-board sheet or a winded paper roll.

The term “coated surface” means herein a substrate which has been dispersion coated but which has not been subjected with a heat and pressure activation.

The term “coating” means a coating or a film on the surface of the substrate. Especially coating may exist on a fibre web such as paper or paper-board web.

The term “heat sealable” means herein that at least a part of the substrate with a coating on its surface can be fixed by the effect of the heat and pressure against the same substrate with a coating on its surface or on another uncoated substrate surface and the term “heat sealed” means here a heat sealing process wherein at least a part of the substrate with a coating on its surface is fixed by the effect of the heat and pressure against the same substrate with a coating on its surface or on another uncoated substrate. The substrate is preferably paper.

The heat sealing process includes also a laminating process wherein a laminate structure is made between two papers by laminating or gluing two paper with each other. The first paper is usually coated and the other paper is uncoated one. By laminating these papers together is formed a sandwich structure comprising paper-coating-paper. However, it is also possible to made a laminate structure between two coated papers. In a laminate structure coating acts as a glue between papers but also as a barrier, this means that the coating is multifunctional. This kind of laminated structure between two papers is flexible.

By using the method according to present invention to generate a coating on a substrate, one can achieve following significant advantages:
As mentioned before, a common problem with barrier coatings and films based on natural polymers relates to their poor ability to stand heating without losing their ability to function as water or oxygen barrier in a film or coating. Therefore an important aspect of the present invention is heat sealability of the formed coatings and films. If films or coatings prepared from natural polymers are heated, their barrier properties are affected negatively. The xylan fatty acid ester originating to hydrophobic medium or long chain fatty acids is thermoplastic material providing heat sealability while maintaining its water barrier properties.
Films prepared from natural polymer are usually rigid and thus external plasticizers are needed to obtain a flexible film or coating. The xylan and cellulose fatty acid esters are as such capable to form flexible film structures.
An important aspect of the present method according to invention relates to ability of forming dispersion coated substrates, which can be activated with heat and pressure. By using this kind of new approach, the scale of dispersion coating can be enlarger significantly; one use dilute dispersions or more traditional concentrated dispersion when coated a substrate with a dispersion coating method.
One aspect of the present invention is, that by using the method according to invention one can achieve a coating or film which is made of cellulose or hemicellulose and which enables fixing by heat and pressure activation on the surface of a substrate. This means that these coatings or films can be fixed onto the paper or paper-board substrate by the same thermopressing methods, which are widely used in paper and paper-board making industry. For example, heat activation of the coated substrate can be made by simultaneous heating and pressing against paper or paper-board web, This can be performed by on-line or off-line calender nips by a thermoroll during the dry-end processes in a paper or paper-board making machine.
In the method according to invention there are used water dispersions for coating substrate. The use of water based solvents are economical and nature friendly.

An additional aspect with can be achieved by heat-sealability of the prepared coatings and films is a possibility to make a new kind of environmental products based on cellulose or hemicellulose. According to one important embodiment of the invention a fibre web is dispersion coated with dispersed hemicellulose fatty acid ester or cellulose fatty acid ester for preparing a coated fibre web sheet, which can be made for example from regenerated cellulose. When a mild heat and pressure is applied on said coated surface, (for example in a calendar) a fibre web is produced, wherein a coating is loosely fixed on its surface. This kind of coating delivers water and oxygen through and can be reheated without affecting negatively to its oxygen and water delivering properties or its heat-sealability.

On another preferred embodiment of the invention heat sealability is connected to the starting material wherein free hydroxyl groups of hemicellulose polymer are esterified with hydrophobic fatty acid residues, especially acid derivative of palmitoyl. Preferably hemicellulose polymer is xylan polymer, and xylose units of the prepared xylan ester polymer have an average substitution degree over 0.6.

Cellulose is a polysaccharide comprising a linear chain of several hundred to over ten thousand [beta(1-4) linked D-glucose units.

Cellulose is the structural component of the primary cell wall of green plants and can be also produced by many micro-organisms. For industrial use, cellulose is mainly obtained from wood pulp for making paper or paper board.

The hemicellulose means herein xylans, mannans or arabinogalactans. Depending on the source, their structure varies.

Hemicelluloses are polysaccharides, macromolecular carbohydrates consisting of large number of monosaccharides connected to each other by glycosidic bonds. Hemicelluloses are one of the most abundant renewable biopolymers in the world. Especially wood hemicelluloses, depending on their origin, can be divided into two main components glucuronoxylan and glucomannan. The hemicellulose content in dry wood is between 20 to 35 wt-%.

Mannans have a backbone of mannose units. Glucomannan comprises also glucose units and galactoglucomannan comprises also galactose units. Mannans are the second main components of hemicelluloses found from wood. Glucomannans are mainly found from softwood.

Arabinogalactan is a component of the heartwood of larches, also found in coffee beans. Backbone of arabinogalactans forms from galactose units which are highly branched containing also arabinose and galacturonic acid units.

As to xylans, there exist four main form glucoronoxylan, arabinoglucuronoxylan, neutral arabinoxylan and heteroxylan, which differ from each other in regard to how the xylose backbone is substituted with. The structure of these xylans is as follows:

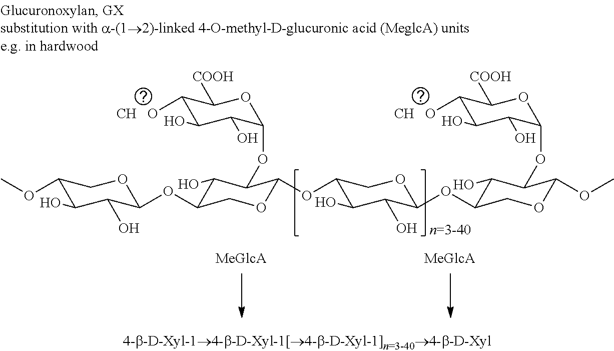

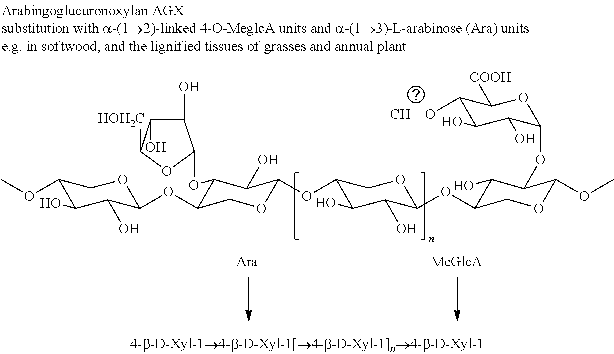

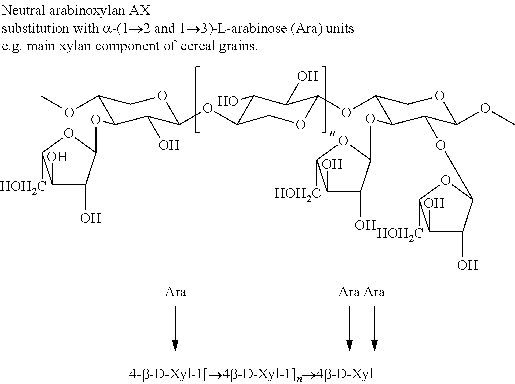

Heteroxylan HX
highly branched with xylose-, arabinose-, and galactose-containing mono-, di-, and trisaccharide side
chains as well as phenolic acid (mainly ferulic acid, FA) esterified to Araf units
presents in cereals, seeds and exudates
HXs are able to form highly viscous aqueous solutions and exhibit exudate gum properties

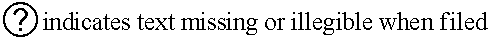

Glucoronoxylan or simply xylan can be found mainly from hardwood and it consists of xylose backbone with a (1-2)-linked 4-O-methyl-D-glocuronic acid units.

Arabinoglucuronoxylan can be found mainly from softwood and the lignified tissues of grasses and annual plant. It has a backbone consisting of xylose units which is substituted with a-(1-2)-linked 4-O-methyl-D-glucuronic acid units and a (1-3)-L-arabinose units.

Neutral arabinoxylan is for instance a main xylan component of cereal grains. There backbone consisting of xylose units is substituted with (1-2 and (1-3)-L-arabinose units.

Heteroxylan can be found from cereals, seeds and execudates and its xylose backbone is highly branched with xylose, arabinose and galactose containing mono, -di-, and trisaccharide chains as well as phenolic acids (mainly ferulic acid) esterified to arabinose units.

A residue originating to fatty acid means herein a residue of aliphatic C₄-C₂₈ fatty acid originating to hydrophilic or hydrophobic fatty acid which can be saturated or unsaturated or to an anhydride of a fatty acid. Preferably this residue is C₅-C₂₂-alkanoyl or C₅-C₂₂-alkenoyl, originating to a saturated or unsaturated short-chain, medium-chain or long-chain fatty acid. Short-chain, medium-chain or long-chain fatty acid means herein a fatty acid with an aliphatic carbon backbone of 4-28 carbon atoms, preferably 5-22 carbon atoms. A residue originating to hydrophobic fatty acid of C₅-C₂₂-alkanoyl residue is preferably palmitoyl, lauroyl, linoleoyl or oleoyl.

A dispersion means herein a system with two or more phases, in which solid, liquid or gas phase is dispersed in a continuous liquid, solid or gas phase. By a rough division, dispersions based on synthetic polymers can be prepared in two ways: by condensation or dispergation methods. In a condensation method dispersion particles are built-up in aqueous medium from monomers using emulsion polymerization reaction. In a dispergating method larger lumps are subdivide into smaller particles in aqueous media. The dispersions prepared by both methods can be controlled and stabilizer by surfactants (Walbridge, 1987). The latter method can be supposed to be suitable for natural polymer dispersions such as cellulose or hemicellulose ester polymer dispersions.

In the method according to present invention a residue originating to fatty acid or ester thereof is reacted with a hemicellulose polymer or cellulose polymer so, that an ester is formed between mentioned hemicellulose polymer or cellulose polymer and said residue originating to said fatty acid or ester thereof. Preferably fatty acid is a hydrophobic fatty acid. This esterifying reaction can be performed by any common ester forming reaction known from this field. This can be performed, for instance, by so called acid catalysed Fisher's esterifying reaction wherein a fatty acid and/or its anhydride is heated while the hemicellulose polymer or cellulose polymer having at least one hydroxyl group is a solvent in a presence of an acid catalyst. Hemicellulose ester polymers or cellulose ester polymers can be made also by reacting cellulose polymer or hemicellulose polymer with at least one hydroxyl group which can be esterified, with an acid chloride of fatty acid. One possible method for preparing cellulose or hemicellulose esters is transesterification process wherein the fatty acid ester is reacted with a hydroxyl group of hemicellulose or cellulose for obtaining corresponding fatty acid ester of hemicellulose or cellulose wherein mentioned fatty acid residue of the ester has an aliphatic carbon tail of 4-28 carbons. This reaction is often catalyzed by the addition of an acid or a base.

According to one aspect of the invention, xylan fatty acid ester polymer is dispersed into water without any organic solvent. The xylan fatty acid ester polymer is insoluble into water which enhances its dispersability into water. Natural polymers are general applied onto a substrate for making barrier films by a solution coating method. In a solution coating method, drying is a limiting factor for forming film due to low solid content of the solution to be used. By using dispersion coating method to apply xylan fatty acid ester polymer onto a substrate, one can raise the solid content of the coated film, which enables faster drying process compared to these usual solution coating processes.

According to another aspect of the invention paper making chemicals are added into aqueous dispersion to be applied onto the paper or paper-board web. Because the substrate is coated with a suitable dispersion coating method these additional paper-making chemicals should be able to form aqueous dispersions possible by using suitable colloidal protecting substance. Possible non-restricting paper making chemicals are pigments, sizes, fillers and plasticizers. These could contain for example talc, CaCO₃, starch, kaolin, bentonit, surfactants and pigments such as titan oxide. Especially bentonit seems to be suitable additive to be used.

Bentonit is a montmorillonite type mineral, sometimes called as nano clay. Bentonite is dispersible into aqueous solutions without additives and is therefore suitable to be used in combination with the hemicellulose fatty acid ester or cellulose fatty acid ester dispersed into aqueous solution. Bentonite may improve to enhance barrier properties of the formed coating or film against water vapour.

However, in this context it should be emphasized, that the prepared coating or film on a substrate, such as fibre web, is heat-sealable on its own, there is no need of additional adhesives for enabling heat-sealing.

Paper making chemical is herein meant any chemical used in paper or paper-board making process except wood or plant fibre.

According to one aspect of the method for preparing a thermoplastic coating, hemicellulose is provided as a pulp, preferable as a pulp slurry, which can be bleached before using it in the mentioned method. If the hemicellulose is xylan, the pulp can be birch kraft pulp. Instead of using the bleached birch kraft pulp as such, it is possible to use pure xylan polymer by isolating xylan from said birch kraft pulp, This can be made for example by alkaline extraction of bleached birch kraft pulp, followed by precipitation or ultrafiltration of xylan polymer.

The invention is illuminated more detailed by following non-limiting example.

Xylan from the bleached birch kraft pulp was used as a starting material in an esterification reaction with a fatty acid chloride (palmitoyl chloride). Palmitoyl chloride was made as follows: palmitic acid (50 g) was dissolved into dichloromethane (CH₂Cl₂) (150 ml). To this solution dimethylformamide (DMF) (cat.) and thionyl chloride (SOCl₂, 46.4 g) were added at room temperature and the mixture was refluxed for 2 h. Excess of SOCl₂ was evaporated and the residue was stripped with CHCl₃ (3×30 ml) and dried in vacuum overnight. Product, palmitoyl chloride, was obtained as brownish oil. Xylan was modified by esterification with this obtained palmitoyl chloride to increase its hydrophobicity and thermoplasticity. Palmitoyl chloride (25 g) was added dropwise at a room temperature to the solution of xylan (5 g) in pyridine. After addition, temperature was raised to 105° C. for 4 hours. Solid was filtered and washed several times with hot ethanol. The white solid product was dried in vacuum overnight. The hypothetical structure of palmitoyl xylan is given in FIG. 2.

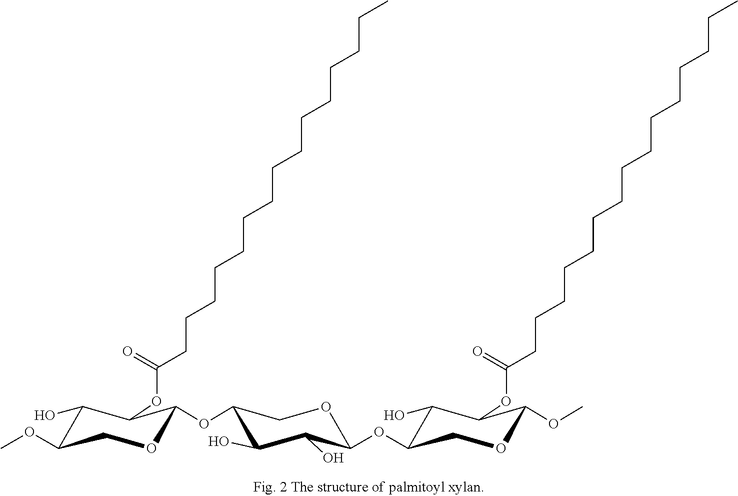

The degree of substitution (DS) of palmitoyl xylan and starting material (xylan) were analysed by the ¹H and ¹³C NMR techniques.

The glass transition temperature (Tg) was measured for xylan and palmitoylated xylan as follows: a differential scanning calorimeter (DSC, DSC20, Metttler-Toledo) was used at a heating rate of 10° C./min and a dynamic heating temperature range from −50 to 200° C. to determine the glass transition temperature (taken from a midpoint) of the xylans before and after esterification. The samples (about 10 mg) were sealed in 40 ul aluminum pans with a pinhole on the lid. Tg was determined from the midpoint of the endothermic transition obtained from the second heating cycle.

A polydispersity value (PD) gives information about molar mass distribution of a sample. A polymer with homogeneous molar mass distribution has the PD value of 1. The PD of the xylan and its derivatives varied from 1.5 to 2 indicating heterogeneous molar mass distribution. In table 1 is given polydispersity value for xylan.

The soluble matter. The xylan and esterified xylan powder was weighted into a breaker followed by water addition to form 1% suspension. The suspension was mixed at room temperature for min by Ultra-Turrax (IKA T18 Basic) mounted with the cutter (S18N-19G). For the first minute the cutter speed of 3500 rpm was used and then raised up to 10000 rpm for the last 4 min. The solution was centrifuged to separate the insoluble matter from the solution at 8800 rpm for 15 min. The soluble matter was determined by weighing approximately 20 g of the solution into evaporation dish followed by drying at 105° C. for overnight. A fraction of the soluble matter was calculated.

TABLE 1
A fraction of the water soluble fraction, the molar mass (Mw),
the polydispersity (PD), the degree of substitution (DS) and the
glass transition temperature (Tg) determined for the xylan and
its derivatives.

| | | | | | | Soluble |
|---|---|---|---|---|---|---|
| | | Mw | | | Tg | matter |
| Sample | Abbr. | (Dalton) | PD | DS | (° C.) | (%) |
| Xylan | X | 20 000 | 1.7 | 0 | 171 | 10.0 |
| Palmitoylated xylan | pX | N/A | N/A | >0.6 | N/A | 1.5 |

The obtained xylan fatty acid ester was dispersed into aqueous solution without additives. The xylan fatty acid ester (2.0 g or 2.7 g) was weighted in a vial (25×85 mm) followed by water addition (6.3 g) to form suspension whose concentration was respectively 23% and 30%. The suspension was dispersed at room temperature for 5 min by Ultra-Turrax (IKA T 18 Basic) mounted with the blender (S18N-10G). For the first minute the cutter speed of 3500 rpm (set value 1) was used and then raised up to 15 000 rpm (set value 4) for the last 4 min.

The dispersion obtained was coated on a base paper. Single coating layer was applied by a laboratory coater (Erichsen) mounted with spiral resulting wet thickness 60 um. A rough xylan fatty acid ester layer on the base paper was obtained after an oven drying at 105° C. for 5 min. The coated base paper was pressed by thermo press using pre heating at 180° C. for 2 min followed by pressing at 180° C. for 3 min under pressure of 1000 psi. As a result a smooth intact coating layer was obtained. The coating prepared by aforementioned procedures from palmitoylxylan has enhanced barrier properties against water vapour, WVTR being 85 g⁻²d⁻¹ at 23° C. at relative humidity of 50%. This value is as good as that of a commercial PLA coated board (84 g m⁻²d⁻¹). For the coating prepared from lauroylxylan or xylan esterified with tall oil (contains mainly palmitic acid, linoleic acid and oleic acid) on a base paper, with similar method as presented above for palmitoylxylan, WTR-values were correspondingly 302 g⁻²d⁻¹ and 302 g⁻²d⁻¹ 283 at 23° C. at relative humidity of 50%. These coatings are also heat sealable and may emit water and oxygen after mild heat-sealing-process.

The heat sealability was verified by preparing sachets from the paper coated by palmitoylxylan, palmitoylxylan+bentonite, layroylxylan or xylan esterified with tall oil. Substrate was folded in half in way that the coated surfaces were face to face. Open edges were heat sealed with Hulme Marting laboratory heat sealing device for 3 sec resulting in an open sachet having the coating inside of it. The sachet was filled with tap water and let stand alone for few minutes. The substrate beneath of the coating layer (outer part) remained visibly dry. The uncoated substrate get waterlogged within a few minutes when water was poured on it.

The seams made of uncoated paper or paper coated with coating made of palmitoylxylan, palmitoylxylan+bentonite, layroylxylan or xylan esterified with tall oil coated were tested. The stripes of the coated and uncoated substrate material were cut for the heat sealing. Two stripes were heat sealed by Hulme Martin laboratory heat sealing device for 3 seconds. In the first set two stripes were place in the way that coated surfaces were face to face. In the second set the uncoated stripe was facing to coated stripe. In the both sets the heat sealed seam was formed. Both of the heat sealed stripes were ripped off when the break up took place in the interface of substrate and coating layer. In the broken up surface the fibers were attached into the coating layer whereas seam line remained intact.

Also as importance is that the above coatings proved to be heat sealable without any auxiliary substances.

From the above mentioned palmitoylxylan coated substrate (paper sheet) was made also a laminate structure. In the heat and pressure activation step for two samples of the dispersion coated substrates were laying partially top of each other (uncoated surface facing coated surface). The laminated structure was formed after the heat and pressure activation step in which two substrates (paper sheets) were glued together. The substrate layers were ripped off when the break up took place in the interface of substrate and coating layer.

1. A method for preparing a thermoplastic coating on a substrate from a hemicellulose polymer or a cellulose polymer wherein the method comprises at least following steps:
providing a cellulose polymer or a hemicellulose polymer having at least one hydroxyl group which can be used for forming cellulose or hemicellulose ester,
reacting hemicellulose polymer or cellulose polymer with a residue originating to hydrophobic fatty acid with an aliphatic carbon tail of 4-28 carbons preferably of 6-22 carbons or ester thereof for obtaining hemicellulose fatty acid ester or cellulose fatty acid ester,
dispersing the hemicellulose fatty acid ester or cellulose fatty acid ester into aqueous solution and
dispersion coating a fibre web with dispersed hemicellulose fatty acid ester or cellulose fatty acid ester for preparing a coated fibre web,
applying heat and pressure on said coated surface of the fibre web for preparing a fibre web with a coating fixed on its surface,
heat-sealing the coating or the fibre web or part thereof with the coating of the same fibre web or an uncoated fibre web.

2. The method according to claim 1, wherein water dispersion of hemicellulose or celluloses fatty acid ester water dispersion to be apply onto the fibre web contains also other paper making chemicals such as talc, CaCO₃, starch, caolin, bentonit, pigments.

3. The method according to claim 1 wherein the fibre web is an endless paper or paper-board web.

4. The method according to claim 1 wherein the fibre web is un-continuous paper or paper-board web such as rolled paper sheet or a paper or paper-board sheet.

5. The method according to claim 3, wherein substrate to be coated is an endless paper web or a rolled paper sheet, and the coated endless paper web or rolled paper sheet is calendered in a calendar having at least one heatable roll device to prepare a coating on a surface of the endless paper web or rolled paper sheet.

6. The method according to claim 1 wherein hemicellulose polymer comprises mainly xylan polymer, mannan polymer or arabinogalactan polymer.

7. The method according to claim 6, wherein hemicellulose polymer to be esterified is xylan polymer, and whereby sugar monomers of esterified xylan ester polymer has an average substitution degree over 0.6.

8. The method according to claim 1, wherein aqueous solution to be used as a continuous phase in dispergation process is water.

9. The method according to claim 1 wherein hydrophilic or hydrophobic fatty acid residue is a saturated or unsaturated, short, medium-chain or long-chain fatty acid having aliphatic carbon tail of 4-28 carbon atoms, preferably 6-22 carbon atoms, still more preferably 12-18 carbon atoms.

10. The method according to claim 9, wherein hydrophobic fatty acid residue is palmitoyl, lauroyl, linoleoyl or oleoyl.

11. A thermoplastic coating on a surface of the fibre web, which coating is prepared from a hemicellulose polymer or a cellulose polymer by:
providing a cellulose polymer or a hemicellulose polymer having at least one hydroxyl group which can be used for forming cellulose or hemicellulose ester,
reacting hemicellulose polymer or cellulose polymer with a residue originating to hydrophobic fatty acid with an aliphatic carbon tail of 4-28 carbons preferably of 6-22 carbons or ester thereof, for obtaining hemicellulose fatty acid ester or cellulose fatty acid ester,
dispersing the hemicellulose fatty acid ester or cellulose fatty acid ester into aqueous solution and
dispersion coating a fibre web with dispersed hemicellulose fatty acid ester or cellulose fatty acid ester for preparing a coated fibre web,
applying heat and pressure on said coated surface of the fibre web for preparing a fibre web with a coating fixed on its surface
heat-sealing the coating or the fibre web or part thereof with the coating of the same fibre web or an uncoated fibre web to prepare a heat sealed coating on a fibre web.

12. The coating according to claim 11, wherein hemicellulose fatty acid ester or cellulose fatty acid ester has been dissolved into an organic solvent and thereafter dispersed solved hemicellulose fatty acid ester or cellulose fatty acid ester into aqueous solvent.

13. The coating according to claim 11 or 12 wherein hemicellulose polymer to be esterified comprises mainly xylan polymer, mannan polymer or arabinogalactan polymer.

14. The coating according to claim 11, wherein hemicellulose polymer to be esterified comprises xylan polymer, and whereby sugar monomers of esterified xylan ester polymer has an average substitution degree over 0.6

15. The coating according to claim 11, wherein aqueous solution to be used as a continuous phase in dispergation process is water.

16. The coating according to claim 11, wherein hydrophobic fatty acid residue of cellulose or hemicellulose ester is originating to saturated, medium-chain or long-chain fatty acid having aliphatic carbon backbone of 4-28 carbon atoms, preferably 6-22 carbon atoms, still more preferably 12-18 carbon atoms.

17. The coating according to claim 16, wherein hydrophobic fatty acid residue is palmitoyl, lauroyl, linoleoyl or oleoyl.

18. The coating according to claim 11, wherein fibre web is made of regenerated cellulose such as sellofan.

19. The coating according to claim 11, wherein dispersion to be applied onto a paper web or a paper board web contains no external plasticizers.

20. The coating according to claim 11, wherein the heat-sealed coating has barrier properties against water.

21. The coating according to claim 11, wherein cellulose polymer or hemicellulose polymer is provided as a pulp or pulp slurry.

22. The coating according to claim 21, wherein hemicellulose polymer is provided as a possibly bleached kraft pulp containing xylans.

23. The use of thermoplastic coating prepared according to a method defined in claim 1 onto a material so that the coated material is substantially breathable.

24. The use of the method according to claim 1 for preparing a thermoplastic coating on a surface of the fibre web, wherein fibre web such as sellofan is calendered in mild temperature before heat sealing for producing a package, in which the coating delivers water and oxygen through and can be reheated without affecting negatively to its water delivering properties.
